(19) United States
(12) Patent Application Publication
(10) Pub. No.: US 2009/0224116 A1
(43) Pub. Date: Sep. 10, 2009

(54) SAW TOOTH AND D-RING HANGER KIT AND SHORT HOLE LOCATOR

(76) Inventor: James M. Gallien, Hidden Hills, CA (US)

Correspondence Address: STETINA BRUNDA GARRED & BRUCKER, 75 ENTERPRISE, SUITE 250, ALISO VIEJO, CA, 92656, US

(21) Appl. No.: 12/043,663

(22) Filed: Mar. 6, 2008

(51) Int. Cl. F16B 47/00; A47F 5/08

(52) U.S. Cl. 248/205.3; 248/205.1

(57) ABSTRACT

There is provided a hanger kit and locator for mounting a wall fixture, with hanger devices, upon a wall and locating the precise location of the hanging devices. The hanger kit includes at least one fastener that is inserted into a wall and is cooperatively engageable with the hanger devices. The hanger kit further provides a locator pin that is temporarily affixed within a hanger device. The wall fixture is temporarily positioned against the surface of a wall such that it abuts the wall. Thereby, resulting in the locator pin creating a reference mark upon the wall. The reference mark is indicative of the precise location of the hanger device. A fastener is inserted in the wall at the reference mark. As a result, the fastener inserted into the wall is spatially relative to the hanger device of the wall fixture. In this regard, the fixture may be secured upon the wall by utilizing the properly spaced fasteners.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates generally to hanging wall mounted fixtures and/or decorations. In particular, the present invention relates to a system and method for locating the correct placement of a hanger device of a fixture relative to a wall or surface to enable such fixture to be mounted on the wall at exactly the desired location.

It is conventional practice to place wall-mounted fixtures, including pictures and decorative objects, against the surface of a vertical wall. The hanging of such fixtures is common in residential settings and commercial environments including public areas where artwork is displayed, such as hotels, motels, or the like. It is common practice in the hanging of such fixtures or like objects to generally involve securing individual hooks, or one or more nails, to a wall and attaching a flexible wire to the back of the object for engaging the nail or hook. Alternatively, a hanger device may be attached to the fixture for engagement on the hook or nail.

It is highly desirable to be able to locate a frame on a wall in the precise position chosen. This is difficult, however, because a variety of hanger devices, such as saw tooth hangers or D-ring attachments, can be located at different places on the frame, and generally are hidden from view behind the frame when the frame is being moved about and positioned on a wall.

With the frame held at its desired position upon a wall, present methods for identifying the point at which a hanging device should be secured to the wall require complicated measuring or marking procedures. These procedures must take into account all of the factors of positioning, including vertical and horizontal placement, size and shape of the frame, location of the unseen cord or other attachment device, and estimation of the position that the attachment device will assume when holding the frame.

The procedure for properly locating a hanger device becomes more complicated when two or more nails, hooks or other hanger devices are used. Employing dual or multiple hanger devices greatly increases the stability of a hanging frame over the use of a single hanger device, thus minimizing slippage, tilt, or other undesirable positions of a hanging frame. However, locating the precise points for securing dual or multiple hanger devices to a wall, properly spaced and in the same horizontal plane, presently requires the special abilities of highly skilled professionals or laymen with similar capabilities.

Oftentimes a user marks the wall to indicate where fasteners, such a screws or nails should be inserted. In order for a fixture to be properly mounted upon a wall it is vital that the fasteners are spatially positioned in relation to the hanger devices of the fixture. A mark is commonly made on the wall with pen, pencil, or chalk, indicating where the fasteners should engage with the wall. However, it is a tedious process to perfectly align the two fasteners upon the wall such that they are engageable with the two keyhole openings.

In order to affix the fixture in perfect alignment, not only must the pair of fasteners be aligned horizontally against the surface wall, but also vertically. In this regard, if the spacing between the fasteners is even slightly incorrect, the fasteners may not fit into the narrow opening of the hanger devices. The subsequent result is that the user must forcibly remove the fasteners from the wall, and repeat the process until they are spaced in accordance to the dimensions of the keyhole openings. This process may require multiple attempts prior to the fasteners being correctly spaced. Consequently, throughout this process numerous holes and markings are created in the wall.

It is a common practice for users to take measurements using rulers or measuring tape to ascertain the distance between the hanger devices; and subsequently attempt to fashion fasteners upon the wall in accordance to those measurements. However, inaccurate measurement techniques and the failure to accurately align the fasteners on both, a vertical and horizontal plane, often results in misplaced fasteners upon a wall. The subsequent result of such inaccurate techniques often leads to frustration and costly damage to the existing wall.

Therefore, in order to overcome the above mentioned deficiencies in the art, there is a need in the art for an improved method and system of hanging wall mounted fixtures on a wall.

### BRIEF SUMMARY

According to an aspect of the present invention there is provided a hanger kit and locator for mounting a fixture upon a wall. In a basic embodiment of the present invention, the hanger kit includes at least one fastener to insert into a wall upon which a fixture is hung. The hanger kit further includes a locator pin to provide a reference mark upon a wall. The reference mark is indicative of the precise location of a hanging device of a fixture. In addition, the hanger kit may come packaged in a manner such that all necessary components to mount a fixture are enveloped in a commercial container designed for display in a departmental store.

In one embodiment of the present invention, the wall fixture may utilize saw tooth hangers, as hanger devices, for hanging the fixture upon the wall. In this regard, the hanger kit is referred to as a saw tooth hanger kit. As such, the wall fixture includes a contact surface and has at least one saw tooth hanger disposed thereto. The contact surface is disposed adjacent to the wall when the wall fixture is secured to the wall. The saw tooth hanger further defines a hanger gap between the saw tooth hanger and the contact surface

The saw tooth hanger kit may include fasteners and a locator pin. Fasteners may be used to secure the wall fixture to the wall. The fasteners may be general standoff fasteners such as nails, screws, or the like. Likewise, the fasteners may be double headed screws as taught by U.S. patent application Ser. No. 11/821,766, incorporated by reference herein in its entirety. As such, the double headed screws are advantageously designed to bear the brunt of larger loads while employed with traditional wall fixtures with hanger devices.

A locator pin may have a flat elongated body having an obverse and a reverse side. In addition, the locator pin has a protrusion on the obverse side extending away from the elongated body. The protrusion may further have a distal end that is capable of marking a wall with a reference mark. A reference mark is indicative of the precise location of the saw tooth hanger on the wall fixture. As such, the user has a visible mark on the wall instructing the user where to insert the fastener into the wall. The locator pin is cooperatively engageable with a saw tooth hanger so that when the wall fixture is secured to the wall, the distal end of the protrusion abuts the wall making a reference mark upon the wall. It is contemplated that one having ordinary skill in the art would recognize that two locator pins may be employed in two saw tooth hangers making two reference marks upon a wall.

In an exemplary embodiment of the present invention, an adhesive may be used to temporarily secure the locator pin within the saw tooth hanger. The distal end of the protrusion may be capable of penetrating the adhesive to expose its cutting edge, such that it may still mark the wall with a reference mark. Conventional tape, gauze, glue, or the like may be utilized to temporarily affix the locator pin within the saw tooth hanger. In addition, the adhesive may be of a convenient size relative to other components of the saw tooth hanger such that it may be commercially packaged as part of the saw tooth hanger kit.

In order to ensure that the reference mark is fashioned in proper alignment, the saw tooth hanger kit may further include a leveling device. Such a leveling device may be operative to assess the horizontal and vertical axes of the fixture in a spatial context relative to the wall. Conventional leveling devices that utilize a bubble tube carried in a cavity adapted to lie on top of a flat surface may suffice. Additionally, a smaller level capable of being packaged with other components of the saw tooth kit may also be adequate.

In a second embodiment of the present invention, a wall fixture may utilize at least one D-ring hanger, as a hanging device, to hang a wall fixture upon a wall. In this regard the hanger kit is conveniently referred to as a D-ring hanger kit. The D-ring hanger is disposed upon the contact surface of the wall fixture. A D-ring hanger includes an assembly of a plate and a ring. The plate is secured to the contact surface whereas the ring is positioned above the plate and may be cooperatively engaged with a fastener. A locator pin may be temporarily affixed upon the contact surface such that the protrusion of the locator pin extends through the ring.

The present invention also includes a methodology of utilizing a saw tooth hanger kit to secure a wall fixture upon a wall. The method includes the step of identifying a desirable position upon the wall to affix the fixture. At this time, a first fastener may be inserted into the wall. The insertion of the first fastener is correlated to the location of a first saw tooth hanger. The method continues by temporarily affixing a locator pin into a second saw tooth hanger using an adhesive. At this time, the fixture is temporarily affixed upon the wall by engaging the first fastener to the first saw tooth hanger. The method may continue by using a level to ensure the fixture is aligned in accordance to appropriate dimensional parameters and visual appeal. Subsequently, sufficient pressure may be applied to the fixture, such that the temporarily affixed locator pin may abut the wall. As a result, the cutting edge of the locator pin may create a reference mark or aperture upon the wall. This reference mark is indicative of the precise location of the second saw tooth hanger. The method may continue by removing the locator pin and adhesive and inserting a second fastener into the wall at the reference mark location. At this time, the fixture may be hung upon the wall by cooperatively engaging both fasteners to the correlating saw tooth hangers. Upon mounting the fixture on the wall, the method may continue by utilizing a level to ensure the fixture is appropriately aligned.

It is contemplated that the present invention addresses the aforementioned deficiencies in the art. As mentioned above, one of the most difficult and frustrating aspects of many prior art wall hanging systems and methods is ensuring that the fasteners are correctly spaced, such that they will connect with the wall fixture and that the wall fixture will be level. The keyhole kit assists a user in this regard by providing the user a reference mark indicative of the keyhole openings' location. Such a system and method should simplify and alleviate the process of hanging a wall fixture.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of a first embodiment of the present invention, where the wall fixture utilizes a pair of saw tooth hangers to hang the fixture.

FIG. 2 is a perspective view of a locator pin configured to fit within a hanger gap of a saw tooth hanger.

FIG. 2a is an elevational view locator pin affixed within the hanger gap between a saw tooth hanger and the contact surface of a wall fixture.

FIG. 3 is a perspective view of a wall fixture, mounted upon a wall, where a pair of fasteners are cooperatively engaged with a pair of saw tooth hangers.

FIG. 4 is a perspective view of a wall, illustrating a first fastener inserted into the wall and a second fastener being inserted into the wall at the reference mark.

FIG. 5 is a perspective view of a pair of fasteners being engaged into a wall, illustrating a wall and the wall fixture, upon which the fasteners are spatially separated in accordance to the dimensions of the saw tooth hangers.

FIG. 6 is a perspective view of a locator pin affixed within a hanger gap, wherein the elongated body of the locator pin extends above and below the saw tooth hanger.

FIG. 7 is a perspective view of a locator pin affixed within a hanger gap, wherein the locator pin is temporarily affixed in the hanger gap by utilizing an adhesive.

FIG. 8 is a perspective view of a wall fixture, upon which a locator pin is temporarily affixed to create a reference mark, where the wall fixture is aligned with a level.

FIG. 9 is a perspective view of a second embodiment of the present invention, where the wall fixture is utilizing a pair of D-ring hangers to hang the fixture upon the wall.

FIG. 10 is a perspective view of a locator pin configured so that the protrusion extends through the ring of the D-ring hanger.

FIG. 11 is a perspective view of a wall fixture utilizing a D-ring hanger and a locator pin.

FIG. 12 is a perspective view of a wall fixture utilizing an adhesive to temporarily affix a locator pin within the ring of a D-ring hanger.

### DETAILED DESCRIPTION

The detailed description set forth below in connection with the appended drawings is intended as a description of the presently preferred embodiment on the invention, and is not intended to represent the only form in which the present invention may be constructed or utilized. The description sets forth the functions and the sequence of steps for developing and operating the invention in connection with the illustrated embodiment. It is to be understood, however, that the same or equivalent functions and sequences may be accomplished by different embodiments that are also intended to be encompassed within the spirit and scope of the invention. It is further understood that the use of relational terms such as first and second, and the like are used solely to distinguish one from another entity without necessarily requiring or implying any actual such relationship or order between such entities.

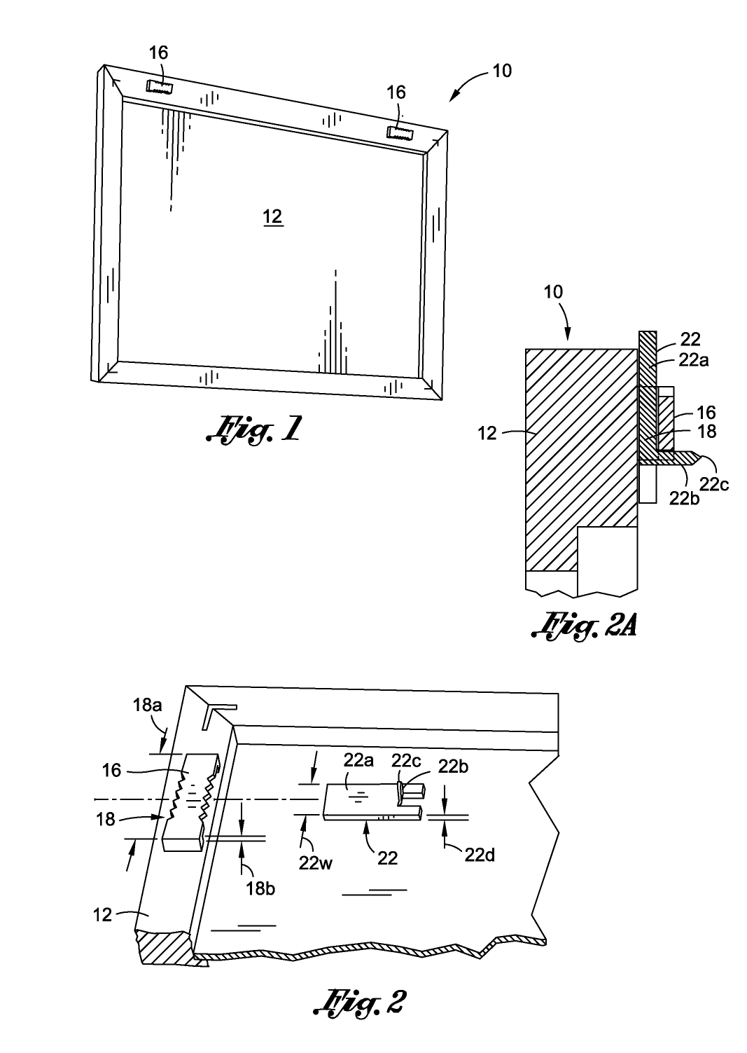

Now referring to FIGS. 1-8, there is provided a hanger kit and locator for hanging a wall fixture upon a wall. According to an aspect of the present invention, the wall fixture 10 may include a contact surface 12 which has at least one hanging device to hang a fixture 10 upon a wall 14. A hanging device may be a hook, nail, saw tooth hanger, D-ring or the like. In one embodiment of the present invention, the wall fixture 10 utilizes two saw tooth hangers 16 to hang a fixture 10 upon the wall 14. In this regard, the hanger kit is hereby referred to as a saw tooth hanger kit. The saw tooth hangers 16 are disposed upon the contact surface 12 of the wall fixture 10 in a horizontal alignment. A saw tooth hanger 16 defines a hanger gap 18 between the saw tooth hanger 16 and the contact surface 12. A hanger gap 18 further defines a hanger width 18a and a hanger depth 18b. The saw tooth hanger kit includes at least one fastener 20 and a locator pin 22.

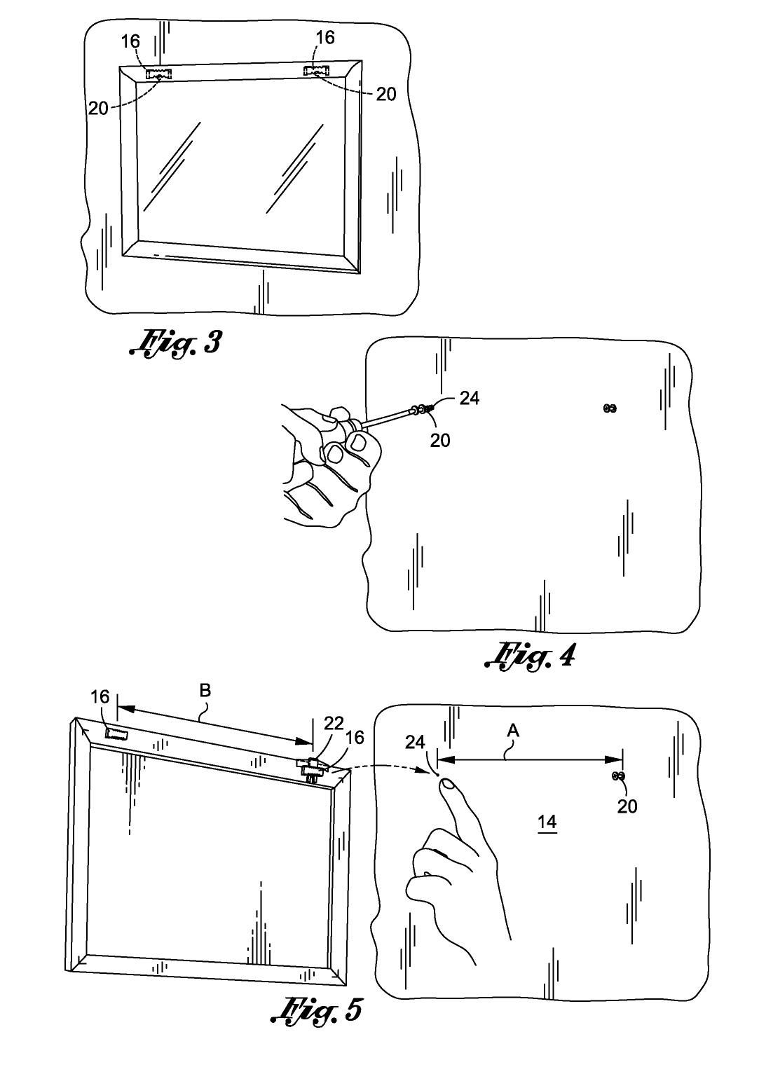

In the present embodiment, the wall fixture 10 is secured to the wall 14 via two fasteners 20. The fasteners 20 may include nails, screws, tacks, hooks or similar hardware known by those skilled in the art. In the present embodiment, the fasteners 20 are double headed screws. As further illustrated by FIG. 4, each fastener 20 is engageable with the wall 14. In this regard, the fastener 20 may be inserted or secured to the wall 14 and capable of supporting a load. The fasteners 20 should have a load capacity sufficient to support the wall fixture 10.

A user must be meticulous when inserting fasteners 20 into a wall 14. It is critical that the fasteners 20 are inserted with precision relative to the distance between the saw tooth hangers 16. FIG. 5 illustrates the horizontal spatial distance between the fasteners 20 shown as A, whereas the horizontal spatial distance between the saw tooth hangers 16 is shown as B. Therefore, A must equal B in order for the fasteners 20 to successfully engage with the saw tooth hangers 16. However, it is oftentimes quite difficult to correctly space the fasteners 20 upon the wall 14. Improperly installed fasteners 20 result in the fasteners 20 having to be removed from the wall 14 and subsequently causing damage to the wall 14.

A locator pin 22 assists a user to properly space fasteners 20 upon a wall 14. As such, a locator pin 22 provides the user with a reference mark 24 upon the wall 14 indicating the location of where the fastener 20 is to be inserted. As further illustrated in FIG. 5, the reference mark 24 is visible to the user. In this regard, a locator pin 22 is temporarily affixed within the hanger gap 18 so that a locator pin 22 abuts the wall 14, and subsequently creates a reference mark 24. As such, a locator pin 22 may include nails, screws, tacks, hooks or similar hardware known by those skilled in the art. A person having ordinary skill in the art would recognize that by employing two locator pins 22 in two saw tooth hangers 16 would make two reference marks 24 upon a wall.

In the present embodiment, the locator pin 22 has a generally flat elongated body 22a having an obverse side and a reverse side. The locator pin 22 has a protrusion 22b on the obverse side that extends away from the elongated body 22a. In addition, the protrusion 22b has a distal end 22c that resultantly abuts the wall 14 and makes the reference mark 24. The locator pin 22 further includes a width 22w and depth 22d. The locator pin 22 is configured such that the width 22w and depth 22d is less than the hanger width 18a and hanger depth 18b. In this regard, the locator pin 22 may be inserted within the hanger gap 18. FIG. 2a provides an exploded view of a locator pin 22 affixed within the hanger gap 18. In the present embodiment, the distal end 22c of the locator pin 22 has converging surfaces which are suitable to form a cutting edge for being driven through or marking a penetratable material such as wood, plaster, plaster board or the like. The protrusion 22b of the locator pin 22 may further have material continuity with the body 22a thereby forming a unitary material. In addition, as illustrated by FIG. 6, the elongated body 22a may extend above or below the saw tooth hanger 16.

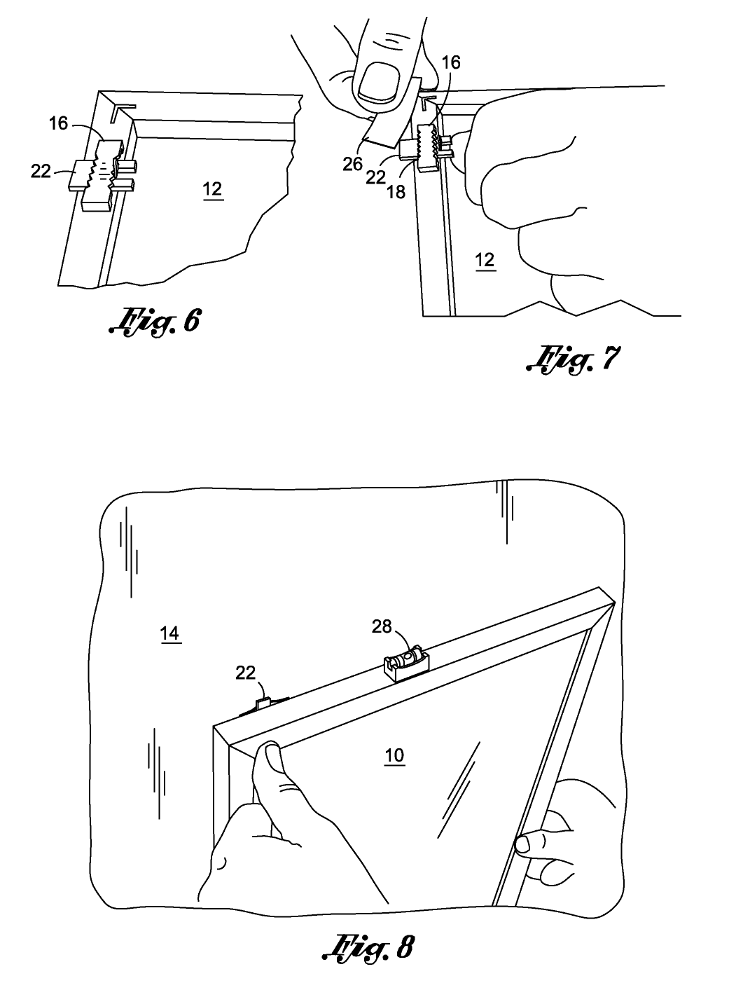

Now referring to FIG. 7, an adhesive 26 is used to temporarily affix the position of the locator pin 22 within the hanger gap 18. In this regard, the adhesive 26 is placed over the locator pin 22 allowing the protrusion 22b to be exposed by penetrating the adhesive 26. The user may secure the position of the locator pin 22 by placing the adhesive 26 on the elongated body 22a that extends above or below the saw tooth hanger. The placement of the adhesive 26 depends largely on the user's ability to properly secure the locator pin 22 in the appropriate position. It is contemplated that an alternative embodiment of the locator pin 22 may include an adhesive strip on the reverse side of the elongated body 22a to temporarily affix the locator pin in the hanger gap 18.

Now referring to FIG. 8, the saw tooth hanger kit may further include a leveling device 28. The leveling device 28 is operative to ensure the wall fixture 10 is level with a horizontal plane. Proper alignment of the locator pin 22 is critical to attain a correct reference mark 24.

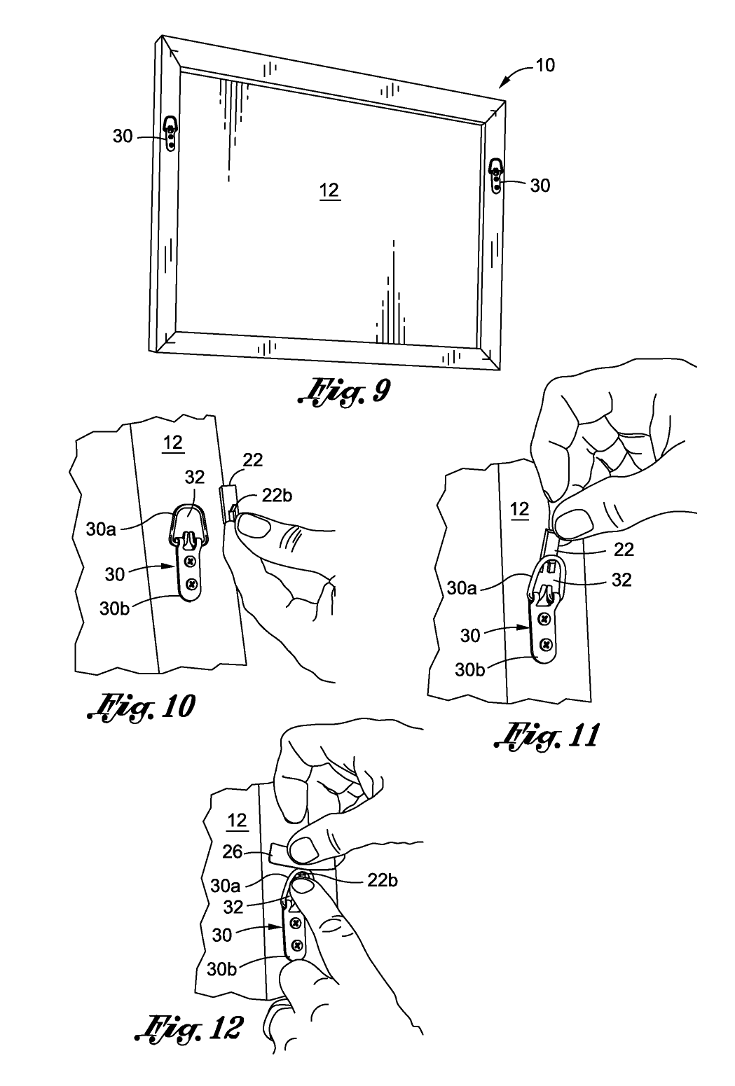

Now referring to FIGS. 9-12 illustrating a second embodiment of the present invention where the hanging device of the wall fixture 10 includes at least one D-ring hanger 30. In this regard, the hanger kit is referred to as a D-ring hanger kit. A D-ring hanger 30 generally includes an assembly of a ring 30a and a plate 30b. In the present embodiment, the wall fixture 10 includes a pair of D-ring hangers 30 disposed upon the contact surface 12 of the wall fixture 10. In a typical D-ring hanger 30, the plate 30b is secured to the contact surface 12 via screws and the ring 30a is positioned above the plate 30b. In addition, the ring 30a has an opening 32 through which a fastener 20 extends to support the fixture 10. A D-ring hanger kit includes at least one fastener 20 and a locator pin 22.

In the present embodiment, the fastener 20 and locator pin 22 as utilized by a D-ring hanger kit are the same as those utilized by a saw tooth hanger kit. In this regard, the head of a fastener 20 is configured to fit within the ring opening 32. Similarly, the protrusion 22b of the locator pin is configured such that it extends through the ring opening 32. In addition, the locator pin 22 is temporarily affixed to the contact surface 12 such that the protrusion 22b extends through the ring opening 32. In this regard, when the wall fixture 10 is held against the wall 14, such that the contact surface 12 is adjacent to the wall 14, the protrusion 22b abuts the wall 14 making a reference mark 24. FIG. 12 illustrates an adhesive 26 being employed to temporarily affix the locator pin 22 in position, such that the protrusion 22b extends through the ring opening 32 and is held up so that the protrusion 22b makes contact with the top of the ring 30a.

The D-ring hanger kit may further include a leveling device 28. The leveling device 28 is operative to ensure the wall fixture 10 is level with a horizontal plane. Proper alignment of the locator pin 22 is critical to attain a correct reference mark 24.

In addition to the foregoing, it is expressly contemplated that the present invention also includes a methodology of securing a wall fixture 10, with a pair of saw tooth hangers 16, to a wall 14. The method includes identifying a desirable location upon a wall 14 to hang the fixture 10. Subsequently, a first fastener 20 is inserted into the wall 14 at the desired location. The first fastener 20 is intended to engage cooperatively with a first saw tooth hanger 16. It is critical that both fasteners 20 are engaged in the precise location upon the wall 14 relative to the saw tooth hangers 16. The method continues by temporarily affixing a locator pin 22 within a second saw tooth hanger 16. Thereafter, an adhesive 26 is used to affix the locator pin 22 in position within the saw tooth hanger 16. It is critical that the location of the adhesive 26, allows for the protrusion 22b to be exposed. Additionally, it is vital that the protrusion 22b has sufficient exposure such that it abut the wall 20.

The method continues by temporarily affixing the fixture 10 upon the wall 14 by cooperatively engaging the first fastener 20 to the first saw tooth hanger 16. As illustrated by FIG. 8, the method continues by utilizing a leveling device 28 to ensure that the fixture 10 is appropriately aligned. Thereafter, pressure is applied to the fixture 10 such that the protrusion 22b makes a reference mark 24 upon the wall 14. As illustrated by FIG. 8, the user may apply the requisite pressure. In addition, as further illustrated by FIG. 5 the pressure applied should be sufficient such that the protrusion 22b creates a reference mark 24 upon the wall 14. Subsequently, the fixture 10 is removed from the wall 14 and the locator pin 22 along with the adhesive 26 are removed from the fixture 10. As illustrated by FIG. 4, the method continues by inserting a second fastener 20 into the wall 14 at the indicated reference mark 24. As shown by FIG. 3, the method continues by hanging the fixture 10 on the wall by cooperatively engaging both fasteners 20 with both saw tooth hangers 16.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A saw tooth hanger kit for hanging a wall fixture upon a wall, the wall fixture including a contact surface and at least one saw tooth hanger, the contact surface disposed adjacent to the wall when the wall fixture is secured to the wall, the saw tooth hanger disposed upon the contact surface, and the saw tooth hanger defining a hanger gap between the saw tooth hanger and the contact surface, the saw tooth hanger kit comprising:
at least one fastener, the fastener being cooperatively engageable with the saw tooth hanger and the wall to secure the wall fixture to the wall; and
a locator pin including:
a generally flat elongated body having an obverse and a reverse side;
a protrusion on the obverse side extending away from the elongated body, the protrusion having a distal end for marking the wall with a reference mark;
the locator pin being configured to fit within the hanger gap; the locator pin being cooperatively engageable with the hanger gap so that when the wall fixture is secured to the wall the reverse side is adjacent to the contact surface and the obverse side is adjacent to the wall so that the protrusion abuts the wall creating the reference mark upon the wall.

2. The saw tooth hanger kit of claim 1, further including an adhesive to secure the locator pin in the gap of the saw tooth hanger.

3. The saw tooth hanger kit of claim 1, wherein the generally flat elongated body of the locator pin extends above the gap between the saw tooth hanger and the contact surface.

4. The saw tooth hanger kit of claim 1, wherein the generally flat elongated body of the locator pin extends below the gap.

5. The saw tooth hanger kit of claim 1, wherein the protrusion has material continuity with the body to form a unitary material.

6. The saw tooth hanger kit of claim 1, further comprising a leveling device operative to ensure the wall fixture is level with a horizontal plane.

7. The saw tooth hanger kit of claim 1, further comprising a leveling device operative to ensure the wall fixture is level with a vertical plane.

8. A D-ring hanger kit for hanging a wall fixture upon a wall, the wall fixture including a contact surface and at least one D-ring hanger, the contact surface disposed adjacent to the wall when the wall fixture is secured to the wall, the D-ring hanger disposed upon the contact surface, the D-ring hanger includes an assembly of a plate and a ring, wherein the ring includes a ring opening and is disposed above the plate and the plate is secured upon the contact surface, the D-ring hanger kit comprising:
at least one fastener, each fastener being cooperatively engageable with a D-ring hanger and the wall to secure the wall fixture to the wall; and
a locator pin including:
a generally flat elongated body having an obverse and a reverse side;
a protrusion on the obverse side extending away from the elongated body, the protrusion having a distal end for marking the wall with a reference mark, the reference mark defines the desired location of a D-ring hanger upon the wall;
the locator pin being configured so that the protrusion extends through the ring opening; the locator pin being cooperatively engageable with the ring opening so that when the wall fixture is secured to the wall the reverse side is adjacent to the contact surface and the obverse side is adjacent to the wall so that the protrusion abuts the wall creating the reference mark upon the wall.

9. The D-ring hanger kit of claim 8, further including an adhesive to secure the locator pin on the contact surface so that the protrusion is flushed underneath the ring.

10. The D-ring hanger kit of claim 8, wherein the elongated body of the locator pin extends above the ring.

11. The D-ring hanger kit of claim 8, wherein the elongated body of the locator pin extends below the ring.

12. The D-ring hanger kit of claim 8, wherein the protrusion has material continuity with the body to form a unitary material.

13. The D-ring hanger kit of claim 8, further comprising a leveling device operative to ensure the wall fixture is level with a horizontal plane.

14. The D-ring hanger kit of claim 8, further comprising a leveling device operative to ensure the wall fixture is level with a vertical plane.

15. A method of securing a wall fixture to a wall, the wall fixture including a contact surface and a pair of saw tooth hangers, the contact surface disposed adjacent to the wall when the wall fixture is secured to the wall, the pair of saw tooth hangers disposed within the contact surface, each saw tooth hanger defining a hanger gap between the saw tooth hanger and the contact surface, the method comprising the steps of:
a) inserting a first fastener into a wall at a desired location, the first fastener being cooperatively engageable with a first saw tooth hanger;
b) inserting a locator pin into a second saw tooth hanger;
c) affixing the wall fixture upon the wall by cooperatively engaging the first fastener into the first saw tooth hanger;
d) applying pressure over the wall fixture such that the locator pin abuts the wall and makes a reference mark on the wall of the location of the second saw tooth hanger;
e) removing the locator pin from the second keyhole opening;
f) inserting a second fastener into the wall at the reference mark;
g) connecting the pair of fasteners with a respective one of the pair of saw tooth hangers thereby securing the wall fixture upon the wall.

16. The method of claim 11, wherein step (b) further includes the step of affixing an adhesive to temporarily secure the locator pin within the opening of the saw tooth hanger.

17. The method of claim 11, wherein step (c) further includes an operative level to align the wall fixture such that the locator pin is horizontally aligned with the wall.
